(19) United States
(12) Patent Application Publication
(10) Pub. No.: US 2025/0273072 A1
(43) Pub. Date: Aug. 28, 2025

(54) SYSTEM AND METHOD FOR MITIGATING VEHICLE COLLISION WITH A BICYCLE

(71) Applicant: TOYOTA JIDOSHA KABUSHIKI KAISHA, Toyota-shi (JP)

(72) Inventor: Daisuke HASHIMOTO, Tokyo (JP)

(73) Assignee: TOYOTA JIDOSHA KABUSHIKI KAISHA, Toyota-shi (JP)

(21) Appl. No.: 18/590,050

(22) Filed: Feb. 28, 2024

(51) Int. Cl. G08G 1/16; B60K 35/28; B60Q 5/00; B60Q 9/00; B60W 50/14; B60W 50/16

(52) U.S. Cl. CPC G08G 1/166; B60K 35/28; B60Q 5/006; B60Q 9/008; B60W 50/16; B60W 2050/143

(57) ABSTRACT

According to embodiments, a method, for mitigating a collision between a first vehicle and a bicycle in proximity to the first vehicle, is provided. The method may include: obtaining environmental information around the first vehicle; obtaining, from the environmental information, first information associated with the bicycle; receiving, from a second vehicle, second information associated with the bicycle; predicting a trajectory of the bicycle according to the first information and the second information; determining, based on the predicted trajectory, a risk of collision between the first vehicle and the bicycle; and providing, to a driver of the first vehicle, a feedback according to the risk of collision and the predicted trajectory.

### TECHNICAL FIELD

Example embodiments of the present disclosure relate to vehicular safety systems, and more particularly, relate to a collision mitigation system implemented in a vehicle for mitigating a collision with a bicycle.

### BACKGROUND

In the related art, various approaches for mitigating vehicle collisions have been introduced. For example, a Forward Collision Warning (FCW) system uses sensors (e.g., radar or camera) to monitor the road ahead, and alert the driver with visual and/or auditory warnings when an imminent collision is detected. As another example, Automatic Emergency Braking (AEB) detects a potential forward collision and automatically activates the braking system of the vehicle to mitigate the potential collision.

Nevertheless, the systems and approaches in the related art are mainly designed to mitigate collision between motorized vehicles (e.g., cars, trucks, etc.) and require the onboard sensors of the motorized vehicles to have a clear forward view in order to operate effectively. Related art systems and approaches, however, are less effective in mitigating collision between a motorized vehicle and a bicycle, due to at least the following reasons.

To begin with, a bicycle usually has a size smaller than a motorized vehicle and has limited visibility when being driven on the road. Accordingly, the bicycle may be easily blocked by other objects on the road, and a vehicle's view of the bicycle may be easily obstructed by other vehicles ahead. Related art safety systems may be limited in their effectiveness when the clear or direct line of sight to the bicycle is obstructed. Thus, it may be difficult for a vehicle to detect the bicycle, when there are other objects moving around the vehicle or the bicycle. This limitation can result in an increased risk of collisions between the vehicle and the bicycle.

Further, a bicycle may have a complex moving trajectory as compared to a vehicle. Specifically, the trajectory of a bicycle is inherently dynamic and less predictable as compared to a motorized vehicle, due to various influencing factors such as weather conditions, the status of road surfaces, the load carried by the bicycle, the experience level of the cyclist, and other environmental variables or human-centric factors.

By way of example, the behavior of cyclists can vary based on experience, decision-making, reaction times, personality, and the like, introducing complexity and difficulty in anticipating the movement of the bicycle beforehand. For instance, a bicycle may enter the road without any prior signal, the cyclist may suddenly maneuver the bicycle without any specific reason, and the like.

Further, as compared with motorized vehicles, the weight of a bicycle is light and is more susceptible to external influences, such as sudden gusts of wind, uneven road surfaces, changes in load distribution, and the like. Thus, compared to motorized vehicles, bicycles are more likely to be impacted by the tilting angle and may suddenly fall sideways. These factors increase the difficulty and complexity of predicting the trajectory of a bicycle solely based on historical or static data.

In addition, a cyclist may easily access and utilize a bicycle without the knowledge of the traffic rules and regulations. Similarly, a vehicle driver who is from a different region or location may not be aware of the local traffic rules and regulations. For instance, in some regions or locations, it is illegal for a motorized vehicle to drive in parallel to a bicycle, the motorized vehicle should maintain a minimal distance away from the bicycle, and the like. Cyclists or drivers who are not familiar with the local traffic rules and regulations may easily offend the rules and regulations without noticing the same, while at the same time increasing the risk of collision.

In view of at least the above reasons, there is a need to provide a solution to effectively and efficiently mitigate a collision between a vehicle and a bicycle.

### SUMMARY

Example embodiments consistent with the present disclosure provide methods, systems, and apparatuses for effectively and efficiently determining a risk of collision between a vehicle and a bicycle and mitigating the risk of collision thereafter.

According to embodiments, a method, performed by at least one processor of a system in a first vehicle to mitigate a collision between the first vehicle and a bicycle in proximity to the first vehicle, is provided. The method may include: obtaining, from at least one onboard sensor, environmental information around the first vehicle; obtaining, from the environmental information, first information associated with the bicycle, wherein the first information may include one or more of a position of the bicycle, a type of the bicycle and a type of a cyclist who is riding the bicycle; receiving, from a second vehicle, second information associated with the bicycle, wherein the second information may include information captured by one or more onboard sensors of the second vehicle; predicting a trajectory of the bicycle according to the first information and the second information; determining, based on the predicted trajectory, a risk of collision between the first vehicle and the bicycle; and providing, to a driver of the first vehicle, a feedback according to the risk of collision and the predicted trajectory.

According to embodiments, a system for mitigating a collision between a first vehicle and a bicycle in proximity to the first vehicle is provided. The system may include: a memory storage storing computer-executable instructions; and at least one processor communicatively coupled to the memory storage. The at least one processor may be configured to execute the instructions to: obtain, from at least one onboard sensor, environmental information around the first vehicle; obtain, from the environmental information, first information associated with the bicycle, wherein the first information comprises one or more of a position of the bicycle, a type of the bicycle and a type of a cyclist who is riding the bicycle; receive, from a second vehicle, second information associated with the bicycle, wherein the second information comprises information captured by one or more onboard sensors of the second vehicle; predict a trajectory of the bicycle according to the first information and the second information; determine, based on the predicted trajectory, a risk of collision between the first vehicle and the bicycle; and provide, to a driver of the first vehicle, a feedback according to the risk of collision and the predicted trajectory.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a diagram of an example use case in which example embodiments may be implemented;

FIG. 2 illustrates a functional block diagram of an example vehicle system for mitigating a collision between a first vehicle and a bicycle in proximity to the first vehicle, according to one or more embodiments;

FIG. 3A illustrates a diagram of an example use case in which the trajectory of the bicycle is predicted, according to one or more embodiments;

FIG. 3B illustrates a side view diagram of a bicycle on a road, according to one or more embodiments;

FIG. 4 illustrates example aligned graphs associated with a probability distribution of a bicycle and an intensity of a steering feedback, according to one or more embodiments;

FIG. 5 illustrates a block diagram of example components of the vehicle system, according to one or more embodiments; and

FIG. 6 illustrates a flow diagram of an example method for mitigating a collision between a first vehicle and a bicycle in proximity to the first vehicle, according to one or more embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Furthermore, the term “vehicle” described herein refers to motorized vehicles such as a car, a truck, a bus, a motorcycle, and any other suitable type of automobile powered by an engine, motor, or other mechanical means. On the other hand, although the present disclosure is described herein with reference to “bicycle”, it is contemplated that example embodiments of the present disclosure may also be applicable to any other suitable type of non-motorized vehicle or traveling means (e.g., a skateboard, a roller skates, a kick scooter, etc.), without departing from the scope of the present disclosure.

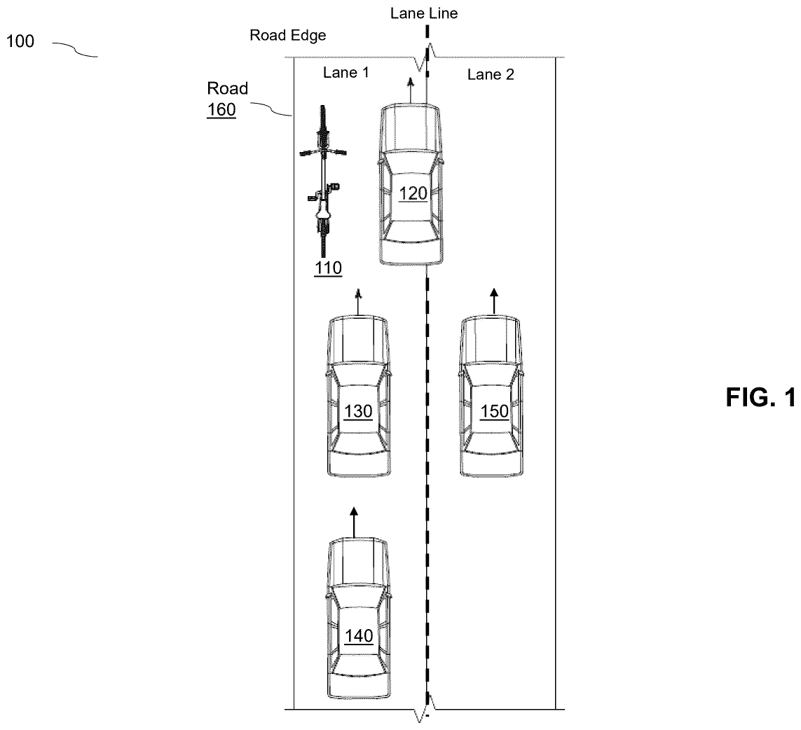

FIG. 1 illustrates a diagram of an example use case in which example embodiments may be implemented. In this example use case, a bicycle 110 and a plurality of vehicles 120-150 are moving on a road 160. The road 160 constitutes a road edge and a lane line that defines two vehicle lanes. The vehicle 120 is driving in parallel to the bicycle 110, while the vehicles 130-150 are driving behind the vehicle 120 and the bicycle 110.

In the related art, the vehicle 140 may not be able to detect the bicycle 110, since the line of sight to the bicycle 110 is blocked by the vehicle 130. Similarly, the vehicle 150 may not be able to detect the bicycle 110, since the line of sight to the bicycle 110 is blocked by the vehicles 120 and 130. These can result in a risk of collisions between one or more of the vehicles 140-150 and the bicycle 110.

On the other hand, the cyclist of the bicycle 110 and the driver of the vehicle 120 may have violated one or more local traffic rules and regulations, but the cyclist and/or the driver may not be aware of the same. For instance, the distance between the vehicle 120 and the bicycle 110 may be narrow and does not satisfy a minimum passing distance specified in the safe passing law or the vulnerable road user law, the road 160 may be located in a no-overtaking zone at which overpassing the bicycle 110 is prohibited, the region at which the road 160 located includes restrictions on driving parallel with bicycles and thus driving in parallel with the bicycle 110 is violating the rules and regulations, the road 160 is dedicated to motorized vehicle and the bicycle 110 should not enter the road 160, and the like.

Example embodiments of the present disclosure enable the vehicles to efficiently determine collision risk and perform one or more operations to mitigate the collision risk, even when direct visibility to the bicycle is hindered. Furthermore, one or more feedbacks may be provided to the drivers and the cyclists, thereby enabling the drivers and cyclists to obtain information regarding the real-time status. For instance, the drivers and the cyclists may be alerted about a potential collision, and may then perform one or more appropriate actions to avoid the collision. In the case where a driver and/or a cyclist violates (or anticipated to violate) one or more traffic rules and regulations, the vehicles to timely notify the associated drivers and/or the cyclists.

According to embodiments, a system may be provided and implemented in a vehicle (“vehicle system” herein). The system may be configured to obtain first information of the bicycle through one or more onboard sensors, while concurrently receiving second information captured by one or more surrounding vehicles. By leveraging the combined information, cooperative sensing among vehicles on the road may be achieved, and the vehicle system can effectively detect the presence of the bicycle, thereby predicting the trajectory of the bicycle and determining a collision risk between the vehicle and the bicycle. Subsequent operations may be performed to prevent the collision, including providing feedback (e.g., visual alert, audio alert, steering control, etc.) to the vehicle driver, sharing the information with surrounding drivers and the cyclist, notifying the vehicle driver and/or the cyclist about the local traffic regulations and laws, and the like.

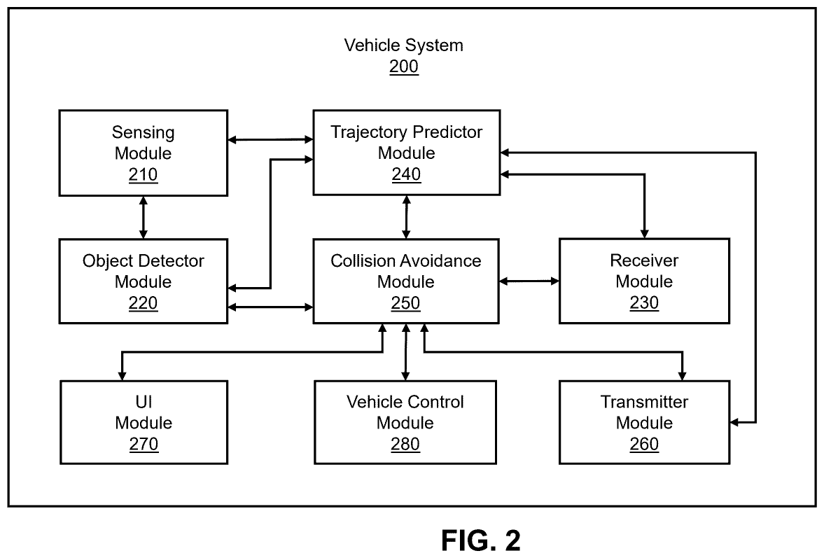

FIG. 2 illustrates a functional block diagram of an example vehicle system 200, according to one or more embodiments. The vehicle system 200 may be implemented in one or more vehicles (e.g., vehicles 120-150) and may interoperate with other systems and components of the vehicle, thereby facilitating efficient and effective collision risk determination and mitigation.

By way of example, the vehicle system 200 may interoperate with the braking system of the vehicle to control the speed of the vehicle according to the collision risk determined by the vehicle system 200, may interoperate with the steering system of the vehicle to provide steering vibration alerts and/or active steering correction according to the determined collision risk and/or a predicted trajectory of the bicycle, may interoperate with the in-vehicle infotainment (IVI) system to provide visual alerts and/or audio alerts to the driver, and may interoperate with any other suitable systems in the vehicle to actively assist the driver of the vehicle in collision avoidance maneuvers and enhance overall vehicle control and stability in potentially collision situations.

As illustrated in FIG. 2, the vehicle system 200 may include a plurality of functional modules 210-280. One or more of the modules 210-280 may be implemented in different forms of hardware, firmware, or a combination of hardware and software. In this regard, it is contemplated that one or more operations described herein with reference to each of the modules 210-280 may be performed by a hardware (e.g., a processor, etc.) upon executing a software or computer-executable instructions for implementing the modules 210-280. Further, it is contemplated that one or more of the modules 210-280 may be consolidated into a single module (e.g., the receiver module 230 and the transmitter module 260 may be combined into a transceiver module, the object detector module 220, the trajectory predictor module 240, and the collision avoidance module 250 may be combined into a collision mitigation module, etc.), without departing from the scope of the present disclosure.

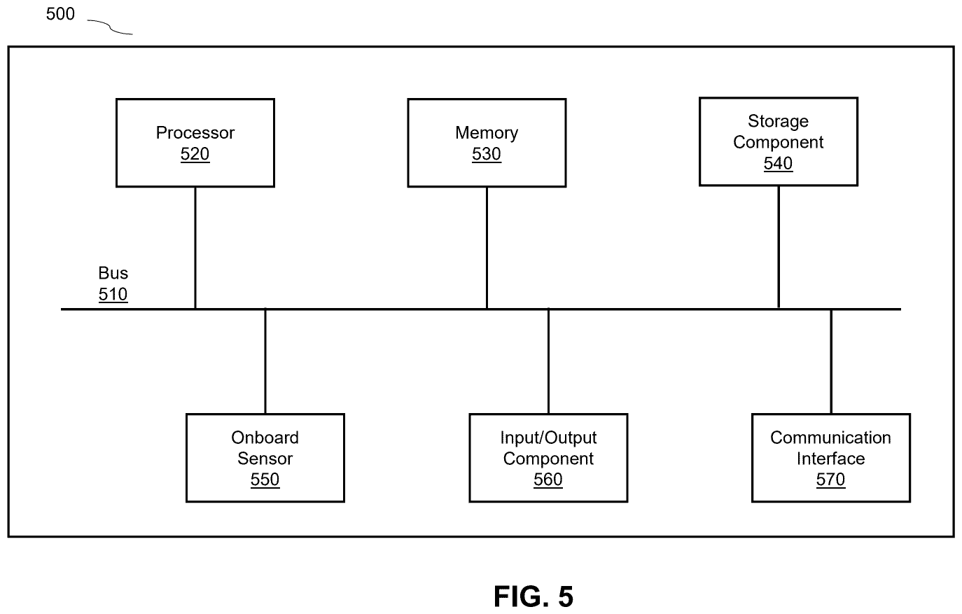

The sensing module 210 may be configured to collect data or information (“sensing data” herein) from various onboard sensors (further described below with reference to FIG. 5), and then perform one or more operations to process the sensing data to consolidate meaningful data and to enhance data accuracy, before providing the sensing data to other modules of the vehicle system 200. For instance, the sensing module may perform one or more data filtering operations to reduce the noise in the sensing data, may perform one or more data calibration to correct systematic errors in the sensing data, may perform one or more data fusion operations to integrate or compile sensing data from multiple sensors to create a comprehensive and coherent representation of the vehicle's surrounding conditions, and the like. Upon processing the sensing data, the module 210 may provide the processed data to other modules of the vehicle system 200 (e.g., the object detector module 220, the trajectory predictor module 240, etc.) for further utilization or processing.

The object detector module 220 may be configured to detect and identify one or more objects of interest in the vehicle's surroundings. Specifically, the object detector module 220 may be configured to detect and extract, from the sensing data provided by the sensing module 210, various information associated with the bicycle (“bicycle information” herein), such as a position of the bicycle, a type of the bicycle, a type of the cyclist, a load on the bicycle, a traveling speed of the bicycle, a steering behavior of the cyclist, a flag defining whether or not the cyclist violates (or is about to violate) one or more traffic rules and regulations, and the like. In some embodiments, the object detector module 220 may be configured to detect and extract, from the sensing data provided by the sensing module 210, various information associated with the road that the bicycle is moving at, such as information of bicycle lane (e.g., dedicated bicycle lane separated from motorized vehicles by physical barriers, buffered bicycle lane with painted buffer zone between the bicycle lane and the road lane, bicycle lane marked with painted lines or dedicated colors, wideness of the bicycle lane, etc.), roadside infrastructure (e.g., barriers, guardrails, etc.), and the like.

According to embodiments, the sensing data may include image data captured by one or more onboard cameras, and the object detection module may perform one or more image processing operations to detect and extract the information of the object of interest (e.g., bicycle, cyclist, bicycle lane, etc.) from the one or more images. For instance, the object detection module 220 may perform one or more operations such as edge detection, histogram analysis, shape or texture detection, and the like, to identify the object of interest from the image data. In some embodiments, the camera can include a front-facing camera which can sense the bicycle ahead the vehicle, a side-facing camera which can sense the bicycle beside the vehicle, and a rear-facing camera which can sense the bicycle behind the vehicle.

According to embodiments, the object detector module 220 may be configured to classify or categorize the detected object(s) into different classes based on the respective characteristics, such as size, shape, and the like. For instance, upon detecting a bicycle, the object detector module 220 may classify the bicycle into a specific type of bicycle, such as a road bicycle, a mountain bicycle, a single-speed/fixed-gear bicycle, a cargo bicycle, a throttle-assist electric bicycle, a pedal-assist electric bicycle, and the like. Similarly, the object detector module 220 may classify the cyclist according to the age of the cyclist, the behavior of the cyclist, the facial expression of the cyclist, and the like. Further, the object detector module 220 may also classify the bicycle according to the load on the bicycle, such as the amount of load at the front/rear of the bicycle, the number of child seats mounted on the bicycle, and the like.

It is contemplated that the object detector module 220 may also be configured to detect and classify other objects, such as vehicles, pedestrians, road markings, traffic signs, road surface status, road lane configurations, bicycle lane, and any other suitable objects or settings surrounding the vehicle or along the traveling route, without departing from the scope of the present disclosure. Such information may be utilized by the vehicle system 200 to determine whether or not a driver and/or a cyclist violates (or is about to violate) one or more traffic rules and regulations. Upon obtaining the information of the object(s) of interest, the object detector module 220 may provide the information to other modules of the vehicle system 200 (e.g., the trajectory predictor module 240, the collision avoidance module 250, etc.) for further utilization or processing.

The receiver module 230 may be configured to receive data or information from one or more devices outside of the vehicle system 200. According to embodiments, the receiver module 230 may perform vehicle-to-vehicle (V2V) communication with one or more surrounding vehicles and vehicle-to-infrastructure (V2I) communication with the external devices like the roadside infrastructure or a radio broadcaster, thereby receiving data or information from other vehicles and external devices in real-time or near real-time. The received information may include bicycle information and environmental information captured by one or more onboard sensors of the surrounding vehicle(s), traffic information, information of local traffic rules and regulations, information of the surrounding vehicle(s) (e.g., traveling speed, current position, etc.), and the like. According to embodiments, the received information may further include an alert or a warning, such as an alert of a potential collision between a surrounding vehicle and a bicycle, an alert about a potential sudden braking of the surrounding vehicle to avoid the collision, a red flag indicating that a specific cyclist and/or a specific driver of the surrounding vehicle may not be familiar with local traffic rules and regulations, and the like.

According to embodiments, the receiver module 230 may be configured to process the received information or data. For instance, the receiver module 230 may decode the encoded information, may perform an error check, may perform a data integrity check, and the like. Further, the receiver module 230 may provide the received information to other modules of the vehicle system 200 (e.g., the trajectory predictor module 240, the collision avoidance module 250, etc.) for further utilization or processing.

The trajectory predictor module 240 may be configured to predict a trajectory of the bicycle in real-time (or near real-time), based on information obtained from the object detector module 220 and the receiver module 230. As described above with reference to the module 220 and module 230, the information being provided to the trajectory predictor module 240 may include various bicycle information (e.g., the traveling speed of the bicycle, the steering behavior of the cyclist, the position of the bicycle, the type of the bicycle, the type of the cyclist, the load on the bicycle, etc.) and various environmental information (e.g., weather condition, time of the day, lighting condition, road conditions, traffic condition, local traffic rules and regulations, etc.), which may be captured by one or more onboard sensors of the vehicle and one or more onboard sensors in the surrounding vehicle(s). In some embodiments, the information being provided to the trajectory predictor module 240 may include the information about the road or lane that the bicycle is moving at.

Based on the received information, the trajectory predictor module 240 may predict or forecast a future trajectory of the bicycle. For instance, the module 240 may predict, based on the bicycle information, one or more of: the bicycle's future motion, the possible path(s) that the bicycle may take, a potential position of the bicycle relative to the vehicle and/or the surrounding vehicle(s), the relative or absolute velocity of the bicycle, and the like.

According to embodiments, the trajectory predictor module 240 may adjust or fine-tune the predicted bicycle trajectory based on the environmental information. For example, the module 240 may consider real-time conditions such as road surface conditions, weather conditions, surrounding visibility, and any other conditions that may affect the bicycle trajectory, and then adjust the predicted bicycle trajectory based thereon.

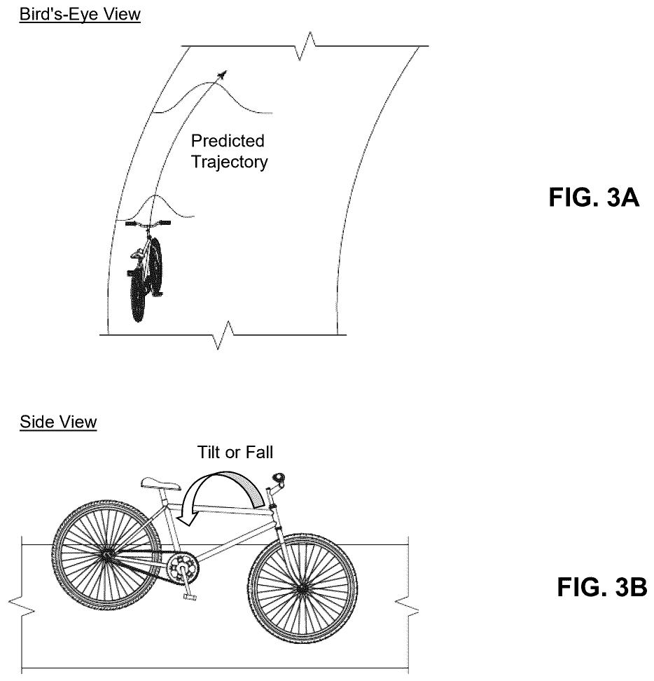

Referring to FIG. 3A, which illustrates a diagram of an example use case in which the trajectory of the bicycle is predicted, according to one or more embodiments. In the example of FIG. 3A, the trajectory predictor module 240 may determine, based on the environmental information, that a curve appears on the road or lane ahead of the bicycle. Accordingly, the module 240 may determine, based on the bicycle information, a trajectory the bicycle may take in view of, for example, the traveling speed of the bicycle, the load on the bicycle, and/or the traveling direction of the bicycle. Accordingly, the module 240 may adjust the determined trajectory based on, for example, the road surface condition, the weather condition, and the like.

According to embodiments, the trajectory predictor module 240 may be further configured to determine or predict a tilting angle of the bicycle. For instance, the trajectory predictor module 240 may determine, based on the bicycle information (e.g., type of bicycle, load of bicycle, traveling speed of bicycle, cyclist behavior, etc.), one or more potential tilting angles of the bicycle.

Referring to FIG. 3B, which illustrates a side-view diagram of a bicycle on a road. As shown in FIG. 3B, the tilting angle of the bicycle defines the angle at which the bicycle tilts or leans sideways (i.e., toward the road) relative to the vertical axis. In other words, the tilting angle represents the angular variation of the bicycle from the upright position. According to embodiments, the module 240 may determine, based on the bicycle information and the environmental information, a threshold of stability which, when exceeded by the tilting angle of the bicycle, causes the bicycle to lose stability and potentially fall sideways. The threshold of stability may be influenced by various real-time factors, including the traveling speed of the bicycle, the coefficient of friction between the tires and the road surface, and the like.

In some embodiments, the module 240 may be configured to compute at least one probability distribution of the bicycle, which provides a probabilistic representation of one or more future motions of the bicycle, accounting for the likelihood or uncertainty of the bicycle. According to embodiments, the module 240 may predict or compute the probability distribution of the predicted bicycle trajectory and predicted tilting angle in a time series. Alternatively or additionally, the module 240 may be configured to compute the probability distribution in terms of the lateral position of the bicycle. The probability distribution may define or represent a likelihood or probability of one or more events, such as: a probability of the bicycle tipping or falling sideways due to excessive tilting, a probability that the bicycle oversteering (turning too sharply) or understeering (not turning enough) during a turn at the predicted trajectory, a probability of the bicycle colliding with obstacles or hazards along its predicted trajectory, a probability that the bicycle violating a local traffic rule and regulation (e.g., trespassing a prohibited area, running parallel with a vehicle, etc.) along the predicted trajectory, and the like.

According to embodiments, the module 240 may predict said probability distribution with one or more probabilistic filtering algorithms (e.g., Kalman filtering, etc.) Further, the bicycle information (e.g., cyclist information, bicycle type, load information, etc.) may be utilized by the module 240 to compute or calculate said probability distribution. Furthermore, the module 240 may adjust or fine-tune the probability distribution based on, for example, one or more of the bicycle information. For instance, the module 240 may adjust the probability distribution according to the type of the cyclist (e.g., increasing the probability of the bicycle suddenly falling sideways based on determining that the cyclist falls under the category of “Child” or “Elder”, etc.), according to the type of and/or the number of loads mounted to the bicycle (e.g., broadening the probability distribution of the trajectory and the tilting angle based on determining that multiple child seats are mounted on the bicycle, etc.), according to the type of bicycle propulsion (e.g., narrowing the probability distribution of the trajectory and the tilting angle based on determining that the bicycle is an electric power-assisted bicycle, etc.), and the like

According to embodiments, the module 240 may be configured to continuously (or periodically) update the trajectory prediction, the tilting angle prediction, and the computation of the probability distribution of the predicted trajectory and tilting angle, based on real-time (or near real-time) information obtained from the onboard sensors and the surrounding vehicle(s), taking into account the immediate status of the bicycle and environmental conditions. Further, the module 210 may provide information of the predicted bicycle trajectory, the predicted tilting angle of the bicycle, and/or the probability distribution of the predicted trajectory and tilting angle to other modules of the vehicle system 200 (e.g., the collision avoidance module 250, the transmitter module 260, etc.) for further utilization or processing.

Referring still to FIG. 2, the collision avoidance module 250 may be configured to determine, based on at least the predicted trajectory of the bicycle, a risk of collision between the vehicle and the bicycle. According to embodiments, the module 250 may compare one or more of: the relative positions between the vehicle and the bicycle, the traveling speeds of the vehicle and the bicycle, and the predicted trajectories of the vehicle and the bicycle, thereby calculating or computing the risk of collision. According to embodiments, the module 250 may dynamically assess the risk of collision by continuously (or periodically) receiving the updated bicycle trajectory from the module 240.

Further, the module 250 may determine the collision risk, taking into consideration whether or not the cyclist and/or driver violates (or has a possibility of violating) one or more traffic rules and regulations. According to embodiments, based on determining that the cyclist/driver violates one or more traffic rules and regulations or the cyclist/driver may not be familiar with the traffic rules and regulations, the module 250 may increase the determined collision risk by a predetermined percentage. By way of example, based on determining that the cyclist may violate one traffic rule, the module 250 may increase the determined collision risk by 5%, and based on determining that the cyclist violated one traffic rule, the module 250 may increase the determined collision risk by 10%, and the like.

Upon determining the risk of collision, the module 250 may perform (or instruct other modules to perform) one or more operations to reduce the risk of collision and to mitigate a potential collision between the vehicle and the bicycle.

According to embodiments, the module 250 may instruct the user interface (UI) module 270 to generate one or more user interfaces to provide, to the driver of the vehicle, one or more feedbacks according to the risk of collision and/or the predicted trajectory. For instance, the UI module 270 may generate, based on the risk of collision, at least one graphical user interface (GUI) including a visual alert corresponding to the risk of collision (e.g., the visual alert may have a first color intensity corresponding to a first level of collision risk and a second color intensity corresponding to a second level of collision risk, may include a first icon corresponding to the first level of collision risk and a second icon corresponding to the second level of collision risk, etc.) and/or at least one voice user interface (VUI) including an auditory alert corresponding to the risk of collision (e.g., the auditory alert may have a first volume corresponding to the first level of collision risk and a second volume corresponding to the second level of collision risk, etc.). Subsequently, the module 270 may provide the at least one GUI to a visual device in the vehicle (e.g., a heads-up display (HUD), an infotainment display, a display of a navigation device, etc.), and provide the at least one VUI to an auditory device in the vehicle (e.g., a speaker, a buzzer, etc.), thereby presenting the visual alert and/or the auditory alert to the driver.

According to embodiments, the module 250 may instruct the vehicle control module 280 to perform one or more vehicle control operations according to the risk of collision and/or the predicted trajectory. For instance, the vehicle control module 280 may calculate an optimal steering angle and trajectory adjustments required to maintain a safe separation distance from the bicycle while maintaining the vehicle's stability, and then provide a steering guidance to adjust the vehicle's steering wheel based on the optimal steering angle, thereby creating a virtual barrier or a safety zone between the vehicle and the bicycle. As another example, the vehicle control module 280 may send a signal to the vehicle's electronic control unit (ECU) to activate a vibration motor located within the steering wheel, such that the vibration motor may generate a vibration of the steering wheel according to the respective risk of collision (e.g., the steering wheel vibration may have a first strength/intensity corresponding to the first level of collision risk and a second strength/intensity corresponding to the second level of collision risk, etc.). It is contemplated that the vehicle control module 280 may perform any other suitable operations, such as controlling the braking system or the throttle system of the vehicle, thereby reducing the mitigation risk and avoiding the collision, without departing from the scope of the present disclosure.

According to embodiments, the module 250 may provide, to the transmitter module 260, the information associated with the collision risk avoidance, such as the information regarding the risk of collision, the information regarding the visual alert and/or the auditory alert (obtained from the UI module 270), and/or the information regarding the vehicle control (obtained from the vehicle control module 280). The transmitter module 260 may be configured to receive, from the module 250, the collision risk avoidance information, and receive, from the module 240, the information of the predicted trajectory and tilting angle of the bicycle and the information of the probability distribution thereof. Accordingly, the transmitter module 260 may transmit said information to one or more surrounding vehicles via V2V communication and/or to a device associated with the cyclist of the bicycle via a cellular network.

According to embodiments, in which the module 250 determines that a driver and/or a cyclist violates (or has a certain possibility of violating) one or more traffic rules and regulations, the module 250 may instruct the module 260 to share the information with one or more associated users. In some implementations, the module 260 may provide an alert or notification, along with the associated traffic rule(s) or regulation(s), to the driver and/or cyclist that is associated with the violation. Alternatively, the module 260 may broadcast the information of the driver and/or cyclist to surrounding vehicles or bicycles, along with the associated traffic rule(s) or regulation(s).

According to embodiments, one or more of modules 210-280 may utilize and leverage one or more artificial intelligence (AI) and/or machine learning (ML) models to perform one or more operations described herein. For instance, the module 220 may utilize one or more AI/ML models to detect and identify one or more objects from the sensing data, the module 240 may utilize one or more AI/ML models to predict or compute the probability distribution of the predicted bicycle trajectory and tilting angle, the module 250 may utilize one or more AI/ML models to determine appropriate operations for reducing the collision risk, and the like. In some embodiments, the module 220 may utilize one or more AI/ML models (e.g., semantic segmentation model, etc.) to detect a lane that the bicycle is driving at.

Further, one or more of modules 210-280 may be configured to continuously (or periodically) perform one or more operations described herein, based on the real-time (or near real-time) status of the bicycle, the vehicle, and the environmental conditions. For instance, the module 210 may continuously obtain sensing data from one or more onboard sensors, the module 220 may continuously detect the object(s) of interest, the module 230 may continuously obtain information from one or more surrounding vehicles and/or external devices, the module 240 may continuously predict the trajectory and tilting angle of the bicycle, the module 250 may continuously predict the collision risk and determine appropriate operations associated therewith, the module 270 may continuously update the GUI(s) and/or VUI(s) to present the latest information, the module 280 may continuously adjust the vehicle control operation(s) according to the latest collision risk, the module 260 may continuously provide the latest information to one or more surrounding vehicles and the cyclist, and the like.

Next, a non-limiting example use case (in which the operations of the vehicle system 200 are implemented) is described with reference to FIG. 1. Merely for the purposes of descriptions, it may be assumed that each of the vehicles 120-140 have the vehicle system 200 implemented therein.

Referring back to FIG. 1, the vehicle system in the vehicle 130 may obtain, from at least one onboard sensor, environmental information around the vehicle 130. Subsequently, the system may determine, based on the environmental information, first information associated with the bicycle 110. Further, the system in the vehicle 130 may obtain, from the vehicle 120, second information associated with the bicycle 110. The first information may include bicycle information of the bicycle 110, such as one or more of: a position of the bicycle 110, a type of the bicycle 110, a type of the cyclist who is riding the bicycle 110, and the like. The second information may include bicycle information determined by the system of the vehicle 120 based on environmental information (captured by one or more onboard sensors in the vehicle 120) around the vehicle 120, and may further include one or more of: information of the trajectory and tilting angle of the bicycle 110 predicted by the system of the vehicle 120, information of the probability distribution of the predicted trajectory and tilting angle, information of a collision risk determined by the system of the vehicle 120, information of an alert or a warning regarding a potential collision, and information of vehicle control performed by the system of the vehicle 120.

Upon obtaining the first information and the second information, the system in the vehicle 130 may predict a trajectory of the bicycle 110 according to the first information and the second information. It is contemplated that, in some embodiments, the system of the vehicle 130 may further obtain additional information associated with the bicycle 110 from other vehicles (e.g., a vehicle ahead of the vehicle 120, a vehicle from the opposite lane, etc.), and then predict the trajectory of the bicycle 110 based thereon. Further, the system of the vehicle 130 may further predict a tilting angle of the bicycle 110 and compute a probability distribution of the predicted bicycle trajectory and tiling angle.

Upon predicting at least the trajectory of the bicycle, the system in the vehicle 130 may determine, based on the predicted trajectory, a risk of collision between the vehicle 130 and the bicycle 110.

Accordingly, the system in the vehicle 130 may provide, to a driver of the vehicle 130, a feedback according to the risk of collision and the predicted trajectory. For instance, the system of the vehicle 130 may generate, based on the risk of collision, a steering feedback (e.g., a steering wheel vibration and/or a steering guidance that applies corrective steering maneuvers to drive the vehicle 130 away from the bicycle 110 and create a virtual bearer therebetween, etc.) Further, the system of the vehicle 130 may generate, based on the risk of collision, at least one GUI including a visual alert (e.g., a collision warning icon with a color corresponding to the risk of collision, a blinking sign with an intensity corresponding to the risk of collision, an animation simulating the collision, etc.), and then present the at least one GUI to the driver via a display in the vehicle 130 (e.g., a HUD, an infotainment display, a display of a navigation device, etc.) Furthermore, the system of the vehicle 130 may generate, based on the risk of collision, an auditory alert (e.g., an alarm sound or warning buzzer with an audio volume corresponding to the risk of collision, a voice prompt describing the level of the collision risk, etc.)

According to embodiments, the system of the vehicle 130 may compare the latest risk of collision with a previous risk of collision, and then adjust the intensity of the feedback based thereon. Specifically, the system may increase the intensity of the feedback (e.g., increasing a color intensity of a visual alert displayed on a display of the first vehicle, increasing a volume of an auditory alert outputted by a speaker of the first vehicle, increasing a strength of vibration of a steering wheel of the first vehicle, etc.) based on determining that the latest/current risk of collision is higher than the previous risk of collision. Conversely, the system may decrease the intensity of the feedback (e.g., decreasing the intensity of the color of the visual alert, decreasing the volume of the auditory alert, decreasing the strength of vibration of the steering wheel, etc.) based on determining that the latest/current risk of collision is lower than the previous risk of collision.

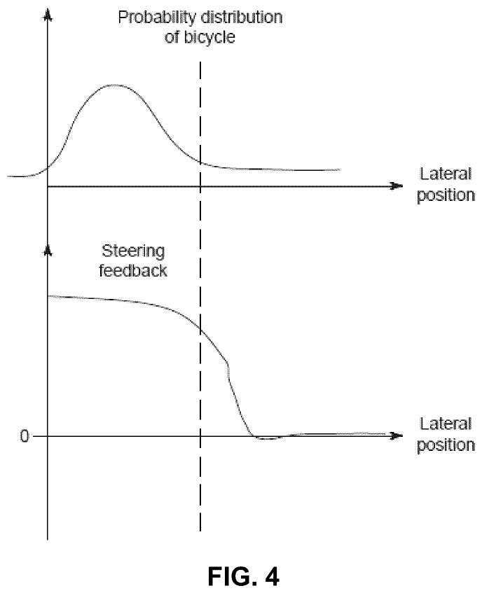

According to embodiments, the system of the vehicle 130 may be configured to adjust the intensity of the feedback according to the probability distribution of the bicycle. Referring to FIG. 4, which illustrates example aligned graphs associated with a probability distribution of a bicycle and an intensity of a steering feedback, according to one or more embodiments. As illustrated in FIG. 4, the bicycle has a probability distribution in terms of the lateral position of the bicycle. The probability distribution may be predicted or computed by the system of the vehicle 130 in real-time (or near real-time) based on the first information (obtained from the sensing module and/or the object detector module) and the second information (obtained from one or more external devices or vehicles via the receiver module). In this regard, the system of the vehicle 130 may also compute or predict, based on the probability distribution of the bicycle, an intensity distribution of the steering feedback representing the predicted or forecasted steering feedback intensity at each lateral position of the bicycle. Accordingly, the system of the vehicle 130 may adjust, based on the intensity distribution, the real-time intensity of the steering feedback. It is contemplated that the system may also adjust the intensity of other feedbacks (e.g., visual alert, auditory alert, steering guidance, braking of vehicle, etc.) in a similar manner, without departing from the scope of the present disclosure.

Referring back to FIG. 1, the system of the vehicle 130 may communicate with the surrounding vehicles (e.g., vehicles 120, 140, and 150) and exchange information therewith. For instance, the environmental information captured by the onboard sensor of the vehicle 130 may include an image showing the bicycle 110 and the vehicle 120, and such information may be useful for the vehicle 120 to determine or enhance the collision risk determination and mitigation operation. Thus, upon obtaining the environmental information, the system of the vehicle 130 may transmit said information to the vehicle 120.

Similarly, information such as bicycle information, predicted bicycle trajectory and tilting angle, probability distribution of the bicycle, collision risk, and the like, obtained or determined by the system of the vehicle 130 may be useful for the vehicle 140 and the vehicle 150, since these vehicles do not have a direct visibility on the bicycle 110. Accordingly, the system of the vehicle 130 may communicate with the vehicle 140 and the vehicle 150 and share the information therewith. In this way, the vehicle 140 and the vehicle 150 may utilize the shared information to effectively determine a collision risk with the bicycle 110 and timely perform one or more operations to mitigate the collision risk, even if the vehicle 140 and the vehicle 150 do not have a direct or clear visibility on the bicycle 110.

In addition, the vehicles 120-150 may continuously (or periodically) communicate and exchange information with each other. In this case, the vehicles 120-150 may utilize the information obtained from other vehicles to cross-reference or validate the information obtained and/or determined by the onboard sensors, utilize the information obtained from one vehicle to cross-reference or validate the information obtained from another vehicle, and the like. By way of example, the vehicle 130 may utilize the information obtained from the vehicle 120 to validate the accuracy or integrity of the information obtained by the onboard sensors. As another example, the vehicle 140 may utilize the information obtained from the vehicle 120 to validate the information obtained from the vehicle 130 or vice versa, before utilizing the obtained information to determine the collision risk or before performing any operation to mitigate the collision risk. In this way, the accuracy of the information utilized for determining the collision risk can be improved, thereby resulting in a precise determination of collision risk and operations for mitigating the collision risk.

Further, upon determining a collision risk, one or more of the vehicles 120-150 may notify or warn the cyclist of the bicycle 110. For instance, the vehicle 120 may provide an alert of a potential collision between the vehicle 120 (or any of the vehicles 130-150) and the bicycle 110 to a device associated with the cyclist of the bicycle. The alert may be provided via a frequency modulation (FM) radio communication, an amplitude modulation (AM) radio communication, a cellular network, a satellite radio communication, a cellular network communication (e.g., 3G, 4G, 5G, etc.), a communication via Bluetooth, a communication via Wi-Fi, and/or any other suitable wireless communication. In this way, the cyclist can be timely alerted about a potential collision and may act proactively (e.g., exit the road, change the bicycle trajectory, reduce the traveling speed, etc.) to avoid the collision. Similarly, upon determining a violation (or a potential violation) of at least one traffic rule/regulation, one or more of the vehicles 120-150 may notify or warn the associated driver and/or cyclist, such that the associated driver and/or cyclist may be aware of the violation and timely take an action to avoid the violation.

Next, descriptions of example components of the vehicle system implementable to one or more vehicles to mitigate a collision with a bicycle are provided. Referring to FIG. 5, which illustrates a block diagram of example components of a vehicle system 500, according to one or more embodiments. The system 500 in FIG. 5 may correspond to the system 200 in FIG. 2, thus it is contemplated that features described herein with reference to the system 200 and the system 500 may be applicable to each other, unless explicitly described otherwise. Further, one or more components of the system 200 (e.g., modules 210-280) may be implemented by one or more components of the system 500.

As illustrated in FIG. 5, the system 500 may include at least one bus 510, at least one processor 520, at least one memory 530, at least one storage component 540, at least one onboard sensor 550, at least one input component/output component 560, and at least one communication interface 570. It is contemplated that the system 500 may include more or less components than illustrated in FIG. 5, without departing from the scope of the present disclosure. For instance, in some embodiments, input/output component 560 may include a dedicated input component and a dedicated output component that may operate independently from each other, a plurality of storage components 540 may be included, and the like.

The at least one bus 510 may include one or more components that permit communication among the components of system 500 and permit communication among said components and other systems/components in the vehicle. For instance, the bus 510 may include a controller area network (CAN) bus, a local interconnect network (LIN) bus, an Ethernet bus, and any other suitable types of bus that allow vehicle components, such as components 520-570, actuators, Electronic Control Units (ECUs), and the like, to communicate with each other in real-time (or near real-time).

The at least one processor 520 may be implemented in hardware, firmware, or a combination of hardware and software. According to embodiments, the processor 520 may include a central processing unit (CPU), a graphics processing unit (GPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component. In some implementations, the processor 520 may include one or more processors capable of being programmed to perform one or more operations described herein. Further, the processor 520 may include a plurality of processing units, each of which is dedicated to perform a specific operation (e.g., each of the modules 210-280 in FIG. 2 may be assigned a dedicated processing unit, etc.)

The at least one memory 530 may include a random access memory (RAM), a read-only memory (ROM), and/or another type of dynamic or static storage device (e.g., a flash memory, a magnetic memory, and/or an optical memory) that stores information and/or instructions for use by the processor 520. The at least one storage component 540 may store information and/or software related to the operation and use of the system 500. For example, the storage component 540 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage component 540 may be configured to store computer-readable or computer-executable instructions for implementing one or more modules of the system (e.g., modules 210-280), one or more AI/ML models for implementing the one or more operations of the modules 210-280, one or more sensing data, one or more bicycle information, one or more environmental information, one or more data obtained from external device(s) or other vehicle(s), one or more predicted bicycle trajectories, one or more predicted bicycle tilting angles, one or more probability distributions of the bicycle, one or more risk of collision between the vehicle and the bicycle, one or more historical operations performed for mitigating the previous collision risk(s), one or more feedbacks provided to the driver, one or more information shared with another vehicle(s), one or more map data, one or more traffic rules and regulations corresponding to one or more locations in the map data, and/or the like. The storage component 540 and may provide the stored information to the memory 530 for the execution of the processor 520.

The at least one onboard sensor 550 may include one or more sensors installed in the vehicle and configured to detect, measure, and capture respective sensing data. For instance, the at least one sensor 550 may include one or more of: an accelerometer which measures and captures data associated with the acceleration/deceleration of the vehicle, the vehicle speed, and/or the vehicle travel distance; an image sensor (e.g., camera, etc.) which detects and captures image data surrounding or nearby the vehicle; a light detection and ranging (LiDAR) sensor which detects and captures data associated with light in one or more light spectrums, such as the visible spectrum, the infrared spectrum, the ultraviolet spectrum, and/or any other light spectrums; an audio sensor (e.g., microphone, etc.) which detects and captures audio data internal and/or external to the vehicle; a temperature sensor which measures and captures data associated with temperature internal and/or external to the vehicle; a location sensor (e.g., global positioning system (GPS) receiver, inertial measurement unit (IMU), etc.) which measures and captures data associated with the location, position, and/or orientation of the vehicle; a contact sensor (e.g., pressure detector, impact detector, etc.) which detects and captures data between a portion of the vehicle and an object; an air sensor which measures and captures data associated with the air (e.g., oxygen level, pollution level, humidity level, etc.) internal and/or external to the vehicle; a weather sensor (e.g., rain sensor, snow sensor, wind speed sensor, visibility sensor, etc.) which measures and captures the weather conditions (e.g., possibility and intensity of rainfall, presence of snow or snow accumulation, direction of wind flow and potential wind gusts, potential fog/mist/haze, etc.) around the vehicle; a proximity sensor (e.g., ultrasonic sensor, LiDAR, radar, etc.) which measures the distance between the vehicle and an surrounding object (e.g., a bicycle); an FM/AM receiver which detects radio signal from a road infrastructure of a radio station, thereby receiving information (e.g., broadcast weather reports, traffic updates, emergency alerts, local traffic rules and regulations, etc.); and any other sensors suitable to be deployed in the vehicle.

The at least one input/output component 560 may include one or more input components that enable the system 500 to receive information such as via user input (e.g., a touch screen display, a keyboard, a keypad, a mouse, a button, a switch, and/or a microphone). Additionally or alternatively, the input/output component 550 may include one or more output components that provide output information from the system 500 (e.g., a display, a speaker, a navigation device, one or more light-emitting diodes (LEDs), etc.)

The at least one communication interface 570 may include a transceiver-like component (e.g., a transceiver and/or a separate receiver and transmitter) that enables the system 500 to communicate with other devices, such as via a wired connection, a wireless connection, or a combination of wired and wireless connections. Communication interface 570 may permit system 500 to receive information from one or more devices outside the vehicle (e.g., one or more devices in other vehicles, a device implemented in a road infrastructure, a device on a bicycle, etc.) and/or provide information thereto. For example, communication interface 570 may include an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 570 may include at least one input/output (I/O) interface, at least one network interface, at least one sensor interface, at least one storage interface, or the like, that enable the components 520-560 to communicate with other devices outside of the vehicle. Further, the communication interface 570 may include one or more application programming interfaces (APIs) that allow the system 500 (or one or more components included therein) to communicate with one or more software applications (e.g., software application deployed in a device of the cyclist, software application implemented in the vehicle system of surrounding vehicles, etc.) According to embodiments, the receiver module 230 and the transmitter module 260 (or one or more operations associated therewith) may be implemented by the communication interface 570.

System 500 may perform one or more operations described herein in response to the at least one processor 520 executing computer-executable instructions for implementing one or more of the functional modules 210-280 in FIG. 2. These computer-executable instructions may be stored by a non-transitory computer-readable recording medium, such as memory 530 and/or storage component 540. A computer-readable medium is defined herein as a non-transitory memory device. A memory device may include memory space within a single physical storage device or memory space spread across multiple physical storage devices.

Computer-executable instructions (e.g., software instructions, etc.) may be read into memory 530 and/or storage component 540 from another computer-readable medium or from another device (e.g., a remote server, an external storage, etc.) via the communication interface 570. When executed, the computer-executable instructions stored in memory 530 and/or storage component 540 may cause the processor 520 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

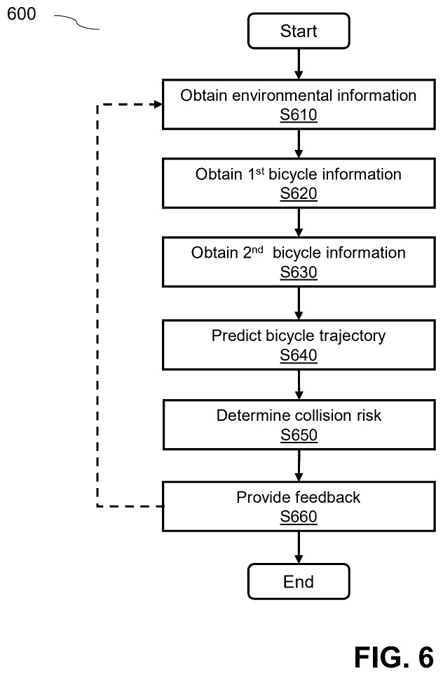

FIG. 6 illustrates a flow diagram of an example method 600 for mitigating a collision between a first vehicle and a bicycle in proximity to the first vehicle, according to one or more embodiments. The method 600 may be performed by at least one processor (e.g., processor 520) of a system implemented in the first vehicle (e.g., the vehicle system 200, the vehicle system 500, etc.), upon executing the associated computer-instructions stored in at least one memory storage (e.g., memory 530, storage component 540, etc.) of the system.

Referring to FIG. 6, at operation S610, the at least one processor may be configured to obtain, from at least one onboard sensor (e.g., onboard sensor 550), environmental information around the first vehicle. The environmental information may include information of one or more objects around the vehicle (e.g., a bicycle, a road obstacle, another vehicle, etc.), lane information (lane that the bicycle is moving at), weather condition (e.g., sunny, raining, fogging, snowing, etc.), timing information (e.g., current time, daytime, nighttime, etc.), lighting condition (e.g., bright environment, dark environment, etc.), road conditions (e.g., slippery road, uneven road surface, curvy road, etc.), traffic information (e.g., congested traffic, local traffic rules and regulations, etc.), history of previous bicycle accidents near the point where the bicycle is moving, and the like. According to embodiments, the at least one onboard sensor may include a camera, and the environmental information may include at least one image captured by the camera.

Operation S610 may be performed by the at least one processor upon executing the computer-readable instructions for implementing a sensing module, of which the specific operations have been described above with reference to module 210 in FIG. 2. Thus, further descriptions regarding the specific operations for obtaining the environmental information may be omitted below for conciseness.

Upon obtaining the environmental information, the method 600 may proceed to operation S620, at which the at least one processor may be configured to obtain, from the environmental information, first information associated with the bicycle. The first information may include one or more of: a position of the bicycle, a type of the bicycle, and a type of a cyclist who is riding the bicycle. According to embodiments in which the environmental information includes the at least one image, the at least one processor may perform one or more image processing on the at least one image to identify the objects of interest (e.g., bicycle, cyclist, etc.), and then perform one or more classification/categorization operations to determine the type of the bicycle, the type of cyclist, and the position of the bicycle.

Operation S620 may be performed by the at least one processor upon executing the computer-readable instructions for implementing an object detector module, of which the specific operations have been described above with reference to module 220 in FIG. 2. Thus, further descriptions regarding the specific operations for detecting and extracting the first information from the environmental information may be omitted below for conciseness.

Referring still to FIG. 6, at operation S630, the at least one processor may be configured to receive second information associated with the bicycle. The second information may be obtained from a second vehicle, and may include information captured by one or more onboard sensors of the second vehicle and information computed based thereon. For instance, the second information may include environmental information captured by the onboard sensors of the second vehicle, bicycle information obtained by the system of the second vehicle based on the associated environmental information, information of a bicycle trajectory predicted by the system of the second vehicle, information of a bicycle tilting angle predicted by the system of the second vehicle, a probability distribution of the bicycle predicted or computed by the system of the second vehicle, a risk of collision determined by the system of the second vehicle, a feedback generated by the system of the second vehicle according to the associated risk of collision and the predicted trajectory, an alert/warning of a potential collision generated by the system of the second vehicle, a red flat indicating that the cyclist and/or the driver of the second vehicle may not be familiar with the local traffic rules and regulations, and the like. Additionally or alternatively, the at least one processor may be configured to obtain the second information directly from a device (e.g., a mobile device of the cyclist, etc.) deployed on the bicycle.

Operation S630 may be performed by the at least one processor upon executing the computer-readable instructions for implementing an receiver module, of which the specific operations have been described above with reference to module 230 in FIG. 2. Thus, further descriptions regarding the specific operations for receiving the second information may be omitted below for conciseness.

Notably, operations S610-S630 may be performed in any suitable sequence, without departing from the scope of the present disclosure. For instance, operation S630 may be performed currently with operations S610 or S620, subsequent to operations 610 or S620, or prior to operations S610 or S620.

Upon obtaining the first information and the second information, the method 600 may proceed to operation S640, at which the at least one processor may be configured to predict a trajectory of the bicycle according to the first information and the second information. According to embodiments, the at least one processor may further predict a tilting angle of the bicycle, and compute a probability distribution of the bicycle based on the predicted trajectory and predicted tilting angle.

Operation S640 may be performed by the at least one processor upon executing the computer-readable instructions for implementing a trajectory predictor module, of which the specific operations have been described above with reference to module 240 in FIG. 2. Thus, the specific operations for predicting the bicycle trajectory may be omitted below for conciseness.

Upon predicting the bicycle trajectory, the method 600 may proceed to operation S650, at which the at least one processor may be configured to determine, based on the predicted trajectory, a risk of collision between the first vehicle and the bicycle. Operation S650 may be performed by the at least one processor upon executing the computer-readable instructions for implementing a collision avoidance module, of which the specific operations have been described above with reference to module 250 in FIG. 2. Thus, the specific operations for determining the collision risk may be omitted below for conciseness.

Upon determining the collision risk, the method 600 may proceed to operation S660, at which the at least one processor may be configured to provide, to a driver of the first vehicle, a feedback according to the risk of collision and the predicted trajectory. According to embodiments, the providing the feedback may include generating, based on the risk of collision, a steering feedback. The steering feedback may include at least one of: a steering vibration and a steering guidance away from the bicycle.

According to embodiments, the feedback may include an alert of a potential collision between the first vehicle and the bicycle. In this regard, the providing the feedback may include generating, based on the risk of collision, at least one GUI including a visual alert, and presenting the at least one GUI to the driver via a display in the first vehicle. Additionally or alternatively, the providing the feedback may include generating, based on the risk of collision, an auditory alert, and presenting the auditory alert to the driver via a speaker in the first vehicle.

According to embodiments, in addition to providing the feedback to the driver of the first vehicle, the at least one processor may be configured to provide the feedback (e.g., the alert of the potential collision, etc.) to a third vehicle, and/or provide the feedback (e.g., the alert of the potential collision, etc.) to a device associated with the cyclist of the bicycle. In some implementations, the at least one processor may provide the feedback to the third vehicle, with or without the first information (obtained at operation S620).

Operation S660 may be performed by the at least one processor upon executing the computer-readable instructions for implementing one or more of a UI module, a vehicle control module, and a transmitter module, of which the specific operations have been described above with reference to module 270, module 280, and module 260, respectively, in FIG. 2. Thus, further descriptions regarding the specific operations for determining the collision risk may be omitted below for conciseness.

Upon providing the feedback, method 600 may be ended or terminated. Alternatively, method 600 may return to operation S610, such that the at least one processor may repeat the operations S610-S660 for at least a predetermined period of time. In this way, the vehicle system may continuously or repeatedly determine the risk of collision with the bicycle, based on real-time status of the bicycle and actual environmental conditions.

It is contemplated that the operations illustrated in FIG. 6 are merely example operations which may be performed by the vehicle system of the example embodiments, and the scope of the present disclosure should not be limited thereto. Specifically, the at least one processor of the system may also be configure to implement or perform one or more additional operations of the modules 210-280.

For instance, when providing the feedback to the driver(s) and/or cyclist, the at least one processor may compare the latest/current risk of collision (determined at operation S650) with a previous risk of collision (determined at a previous operational loop(s)), and then adjust the intensity of the feedback based thereon. For instance, the at least one processor may increase the intensity of the feedback (e.g., increasing a color intensity of the visual alert, increasing a volume of the auditory alert, increasing a strength of the steering wheel vibration, etc.) based on determining that the latest/current risk of collision is higher than the previous risk of collision. Conversely, the system may decrease the intensity of the feedback (e.g., decreasing the color intensity of the visual alert, decreasing the volume of the auditory alert, decreasing the strength of the steering wheel vibration, etc.) based on determining that the latest/current risk of collision is lower than the previous risk of collision. In this manner, the feedback presented to the driver(s) and/or cyclist(s) may adapt to changing conditions in real-time (or near real-time), thereby enhancing the effectiveness of collision prevention and mitigation.

In view of at least the above, example embodiments of the present disclosure address the challenges posed by the dynamic nature of bicycle behavior and status. Specifically, example embodiments allow the vehicles to capture environmental information and share the captured information with surrounding vehicles, thereby achieving cooperative sensing among the vehicles in real-time (or near real-time). Accordingly, example embodiments enable a vehicle to efficiently and effectively predict and prevent a collision with a bicycle, particularly in scenarios where the clear or direct visibility of the bicycle is not available.

Further, the driver(s) or cyclist(s) who are not familiar with the local traffic rules and regulations can be timely notified and alerted, and corrective actions may be performed by the driver(s) or cyclist(s), further reducing the risk of collision while avoiding violating the local traffic rules and regulations.

Furthermore, example embodiments leverage adaptive predictive adaptive predictive analytics based on real-time bicycle information and environmental conditions, thereby enabling the vehicle system to dynamically adjust the collision risk predictions and the collision risk mitigation operations according to changing conditions.

To this end, example embodiments provide robust and accurate collision risk predictions in dynamic environments, enhance the effectiveness of collision prevention operations, and improve the safety of both the drivers and cyclists in conditions where the trajectory and behaviors of the bicycle are less predictable. Further, example embodiments also provide human-centric safety enhancement by automatically presenting suitable feedback to the associated users, leading to more informative predictions and improved collision prevention when the road involves diverse users (e.g., drivers of different type of vehicles, cyclist of different background, etc.)

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method performed by at least one processor of a system in a first vehicle to mitigate a collision between the first vehicle and a bicycle in proximity to the first vehicle, the method comprising:
obtaining, from at least one onboard sensor, environmental information around the first vehicle;
obtaining, from the environmental information, first information associated with the bicycle, wherein the first information comprises one or more of a position of the bicycle, a type of the bicycle and a type of a cyclist who is riding the bicycle;
receiving, from a second vehicle, second information associated with the bicycle, wherein the second information comprises information captured by one or more onboard sensors of the second vehicle;
predicting a trajectory of the bicycle according to the first information and the second information;
determining, based on the predicted trajectory, a risk of collision between the first vehicle and the bicycle; and
providing, to a driver of the first vehicle, a feedback according to the risk of collision and the predicted trajectory.

2. The method according to claim 1, wherein the feedback comprises an alert of a potential collision between the first vehicle and the bicycle.

3. The method according to claim 2, further comprising:
providing, to a third vehicle, one or more of: the first information and the alert of the potential collision.

4. The method according to claim 2, further comprising:
providing, to a device associated with the cyclist of the bicycle, the alert of the potential collision.

5. The method according to claim 1, wherein the at least one onboard sensor comprises a camera, and wherein the environmental information comprises at least one image captured by the camera.

6. The method according to claim 1, wherein the providing the feedback comprises:
generating, based on the risk of collision, a steering feedback, wherein the steering feedback comprises at least one of: a steering wheel vibration and a steering guidance away from the bicycle.

7. The method according to claim 1, wherein the providing the feedback comprises:
generating, based on the risk of collision, a graphical user interface (GUI) including a visual alert; and
presenting, to the driver via a display in the first vehicle, the GUI.

8. The method according to claim 1, wherein the providing the feedback comprises:
generating, based on the risk of collision, an auditory alert; and
presenting, to the driver via a speaker in the first vehicle, the auditory alert.

9. The method according to claim 1, further comprising:
comparing the risk of collision with a previous risk of collision;
based on determining that the risk of collision is higher than the previous risk of collision, increasing an intensity of the feedback; and
based on determining that the risk of collision is lower than the previous risk of collision, decreasing the intensity of the feedback.

10. The method according to claim 9,
wherein the increasing the intensity of the feedback comprises one or more of: increasing a color intensity of a visual alert displayed on a display of the first vehicle, increasing a volume of an auditory alert outputted by a speaker of the first vehicle, and increasing a strength of vibration of a steering wheel of the first vehicle; and
wherein the decreasing the intensity of the feedback comprises one or more of: decreasing the intensity of the color of the visual alert, decreasing the volume of the auditory alert, and decreasing the strength of vibration of the steering wheel.

11. A system for mitigating a collision between a first vehicle and a bicycle in proximity to the first vehicle, the system comprising:
a memory storage storing computer-executable instructions; and
at least one processor communicatively coupled to the memory storage, wherein the at least one processor is configured to execute the instructions to:
obtain, from at least one onboard sensor, environmental information around the first vehicle;
obtain, from the environmental information, first information associated with the bicycle, wherein the first information comprises one or more of a position of the bicycle, a type of the bicycle and a type of a cyclist who is riding the bicycle;
receive, from a second vehicle, second information associated with the bicycle, wherein the second information comprises information captured by one or more onboard sensors of the second vehicle;
predict a trajectory of the bicycle according to the first information and the second information;
determine, based on the predicted trajectory, a risk of collision between the first vehicle and the bicycle; and
provide, to a driver of the first vehicle, a feedback according to the risk of collision and the predicted trajectory.

12. The system according to claim 11, wherein the feedback comprises an alert of a potential collision between the first vehicle and the bicycle.

13. The system according to claim 12, wherein the at least one processor is further configured to:
provide, to a third vehicle, one or more of: the first information and the alert of the potential collision.

14. The system according to claim 12, wherein the at least one processor is further configured to:
provide, to a device associated with the cyclist of the bicycle, the alert of the potential collision.

15. The system according to claim 11, wherein the at least one onboard sensor comprises a camera, and wherein the environmental information comprises at least one image captured by the camera.

16. The system according to claim 11, wherein the at least one processor is configured to provide the feedback by:
generating, based on the risk of collision, a steering feedback, wherein the steering feedback comprises at least one of: a steering wheel vibration and a steering guidance away from the bicycle.

17. The system according to claim 11, wherein the at least one processor is configured to provide the feedback by:
generating, based on the risk of collision, a graphical user interface (GUI) including a visual alert; and
presenting, to the driver via a display in the first vehicle, the GUI.

18. The system according to claim 11, wherein the at least one processor is configured to provide the feedback by:
generating, based on the risk of collision, an auditory alert; and
presenting, to the driver via a speaker in the first vehicle, the auditory alert.

19. The system according to claim 11, wherein the at least one processor is further configured to:
compare the risk of collision with a previous risk of collision;
based on determining that the risk of collision is higher than the previous risk of collision, increasing an intensity of the feedback; and
based on determining that the risk of collision is lower than the previous risk of collision, decreasing the intensity of the feedback.

20. The system according to claim 10,
wherein the at least one processor is configured to increase the intensity of the feedback by one or more of: increasing a color intensity of a visual alert displayed on a display of the first vehicle, increasing a volume of an auditory alert outputted by a speaker of the first vehicle, and increasing a strength of vibration of a steering wheel of the first vehicle; and
wherein the at least one processor is configured to decrease the intensity of the feedback by one or more of: decreasing the intensity of the color of the visual alert, decreasing the volume of the auditory alert, and decreasing the strength of vibration of the steering wheel.
